(19) United States
(12) Patent Application Publication
(10) Pub. No.: US 2007/0265926 A1
(43) Pub. Date: Nov. 15, 2007

(54) AUTOMATED PRODUCT SELECTION AND MANAGEMENT SYSTEM

(75) Inventors: Julie A. Ohmann, Forest Lake, MN (US); Michael Tepper, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/382,947

(22) Filed: May 12, 2006

(51) Int. Cl. G06Q 30/00

(52) U.S. Cl. 705/26

(57) ABSTRACT

In general the invention is directed to systems and methods for an enterprise to identify products that a reseller or potential reseller should sell. In one embodiment, the invention provides a computer-implemented system comprising an enterprise-wide goods and services database storing data that identifies one or more products or services of an enterprise; an enterprise-wide order database storing sales data that identifies past sales of the enterprise's goods and services; and a product selection system comprising a user interface to identify a reseller profile that identifies at least one of the enterprise's resellers, or at least one of the enterprise's potential resellers, and defines at least one characteristic specific to the identified reseller or potential resellers; and an analytical engine executing on one or more computers, wherein the analytical engine calculates a reseller-specific product selection recommendation based on the reseller profile, the sales data, and the goods and services data.

### TECHNICAL FIELD

The invention generally relates to enterprise software products and, more specifically, to software products for optimizing product purchasing by distributors.

### BACKGROUND

Large product manufacturing companies often provide hundreds or even thousands of product offerings. Each product has different features and attributes, and is typically designed for different applications. Often the products span many industries, and are designed to target different potential consumers. These features influence the desirability for the products and ultimately impact consumer-purchasing decisions.

Due to the voluminous number of products and their sometimes subtle differences, it is often difficult for distributors, or retailers to identify the optimal set of products to purchase from a given manufacturing company and offer to their particular customer base. Moreover, the set of products that may deliver a highest return for one distributor may be entirely different for another distributor due to such factors as geographic location, market conditions, seasonal influences, and other variables. For these reasons, a given distributor often has difficulty in identifying the particular product offering that will provide an improved or optimized return on its purchase and resale of products offered by a large company.

### SUMMARY

In general, the invention is directed to computer-assisted techniques for determining product selections for individual distributors, retailers, or other entities. For example, a computerized product selection system is described that provides an interface with which distributors, retailers, salespersons or other authorized users interact. In response to input from a user associated with an entity, such as a distributor or reseller, the computerized product selection system automatically produces electronic product selection reports and other material specifically generated for that entity.

The product selection system may securely access a data warehouse for an enterprise, such as a large manufacturing company, to assemble data describing (1) goods and services provided by the enterprise, (2) enterprise-wide sales data associated with the products offered by the enterprise, and (3) specific sales data for a particular entity. The product selection system performs data analysis techniques on the assembled data to determine a recommended set of products for the particular entity. For example, the product selection system may analyze the data to generate electronic reports that identify a recommended set of products that the entity should purchase from the large manufacturing company in order to increase or potentially maximize a return on investment for the reselling entity. In addition, the product selection system may automatically generate the electronic reports to illustrate actions that the reselling entity may perform to migrate from a current set of products purchased and distributed by the reselling entity to the recommended set or products. Moreover, the product selection system may automatically generate the electronic reports to illustrate potential increased revenues achieved by the reselling entity as a result of the transition.

In one embodiment, the invention is directed to a computer-implemented system comprising an enterprise-wide goods and services database storing data that identifies one or more products or services of an enterprise having a plurality of business units, each business unit offering for sale a plurality of products or services; an enterprise-wide order database storing sales data that identifies past sales of the enterprise's goods and services; a product selection system comprising: a user interface to identify a reseller profile that identifies at least one of the enterprise's resellers, or at least one of the enterprise's potential resellers, and defines at least one characteristic specific to the identified reseller or potential resellers; and, an analytical engine executing on one or more computers, wherein the analytical engine calculates a reseller-specific product selection recommendation based on the reseller profile, the sales data, and the goods and services data.

In another embodiment, the invention is directed to a computer-implemented method comprising receiving, as input, a reseller profile that at least identifies a reseller or potential reseller of an enterprise, the enterprise having a plurality of business units, each business unit having a plurality of products; accessing an enterprise goods and services database to retrieve a portion of the enterprise's product data that defines at least one product available for purchase from the enterprise and not currently sold by the reseller or potential reseller; accessing an enterprise ordering system to retrieve reseller product data, that defines at least one product of the enterprise currently sold by the reseller or potential reseller; and, in response to the input, executing software of a product selection system to automatically provide an electronic report suggesting a set of the products from the enterprise's product data that are not currently sold by the reseller or potential reseller; wherein the report is based on the reseller profile, a prioritized ranking of the product or products comprising the reseller product data, and the enterprise's product data.

In another embodiment, the invention is directed to a computer-implemented method, comprising receiving as input, enterprise product data, which defines a plurality of products available for purchase by a reseller; receiving as input enterprise sales data, which defines at least one business-related attribute about at least one of the plurality of products defined the enterprise product data; receiving as input reseller product data, which defines at least one product sold by the reseller; receiving as input reseller non-carried product data, which defines at least one product not presently sold be the reseller; and, in response to the input, executing software of a product selection system to automatically provide an electronic report suggesting a set of the products from the reseller non-carried product data, wherein the report is based on the enterprise product data, the enterprise sales data, and a prioritized ranking of the product or products comprising the reseller non-carried product data, the prioritized ranking of products based on the business-related attribute.

In another embodiment, the invention is directed to a computer-implemented method, comprising receiving as input enterprise product data, which defines a plurality of products available for purchase by a reseller, and for each product defines the product's category and the product's family, wherein the product category is a class of associated products, and the product family is a sub-class of associated products; receiving as input enterprise sales data, which defines at least one business-related attribute about at least one of the plurality of products defined the enterprise product data; receiving as input reseller product data, which defines at least one product sold by the reseller; determining reseller non-carried product data, which defines at least one product not presently sold be the reseller, by comparing enterprise product data with reseller product data; assigning at least some products in the non-carried product data a category-family ranking, wherein the category-family ranking defines a ranking for families of products within categories of products, the ranking by a business-related attribute; assigning at least some products in the non-carried product data a product-family ranking, wherein the product-family ranking defines a ranking for products within families, the ranking by a business-related attribute; and, generating a product selection recommendation based on the category-family ranking and the product-family ranking.

In another embodiment, the invention is directed to a computer-readable medium having computer-executable instructions for performing a method comprising: receiving, as input, a reseller profile that at least identifies a reseller or potential reseller of an enterprise, the enterprise having a plurality of business units, each business unit having a plurality of products; accessing an enterprise goods and services database to retrieve a portion of the enterprise's product data that defines at least one product available for purchase from the enterprise and not currently sold by the reseller or potential reseller; accessing an enterprise ordering system to retrieve reseller product data that defines at least one product of the enterprise currently sold by the reseller or potential reseller; and, in response to the input, executing software of a product selection system to automatically provide an electronic report suggesting a set of the products from the enterprise's product data that are not currently sold by the reseller or potential reseller; wherein the report is based on the reseller profile, a prioritized ranking of the product or products comprising the reseller or potential reseller's product data, and the enterprise's product data.

In another embodiment, the invention is directed to a computer-readable medium having computer-executable instructions for performing a method comprising: receiving as input enterprise product data, which defines a plurality of products available for purchase by a reseller; receiving as input enterprise sales data, which defines at least one business-related attribute about at least one of the plurality of products defined the enterprise product data; receiving as input reseller product data, which defines at least one product sold by the reseller; receiving as input reseller non-carried product data, which defines at least one product not presently sold be the reseller; and, in response to the input, executing software of a product selection system to automatically provide an electronic report suggesting a set of the products from the reseller non-carried product data, wherein the report is based on the enterprise product data, the enterprise sales data, and a prioritized ranking of the product or products comprising the reseller non-carried product data, the prioritized ranking of products based on the business-related attribute.

In another embodiment, the invention is directed to a computer-readable medium having computer-executable instructions for performing a method comprising: receiving as input enterprise product data, which defines a plurality of products available for purchase by a reseller, and for each product defines the product's category and the product's family, wherein the product category is a class of associated products, and the product family is a sub-class of associated products; receiving as input enterprise sales data, which defines at least one business-related attribute about at least one of the plurality of products defined the enterprise product data; receiving as input reseller product data, which defines at least one product sold by the reseller; determining reseller non-carried product data, which defines at least one product not presently sold be the reseller, by comparing enterprise product data with reseller product data; assigning at least some products in the non-carried product data a category-family ranking, wherein the category-family ranking defines a ranking for families of products within categories of products, the ranking by a business-related attribute; assigning at least some products in the non-carried product data a product-family ranking, wherein the product-family ranking defines a ranking for products within families, the ranking by a business-related attribute; and, generating a product selection recommendation based on the category-family ranking and the product-family ranking.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a high-level view of an example system.

FIG. 2A is a block diagram further illustrating an example central product selection system.

FIG. 2B is a block diagram and flowchart showing high-level information flows through the system to generate a product selection report.

FIG. 3 is a flowchart showing the major steps between when a product selection report is requested and when it is delivered by the system.

FIG. 4 is a flowchart showing the major steps completed by a product selection engine to generate product selection reports.

FIG. 4A, 4B, 4C, and 4D show example data structures or data representations to further illustrate the process illustrated in FIG. 4.

FIG. 5 is an example screenshot of a graphical user interface which facilitates initiation of a request for a product selection report.

FIGS. 6A through 6E are pages from an example product selection report created for a hypothetical reseller.

### DETAILED DESCRIPTION

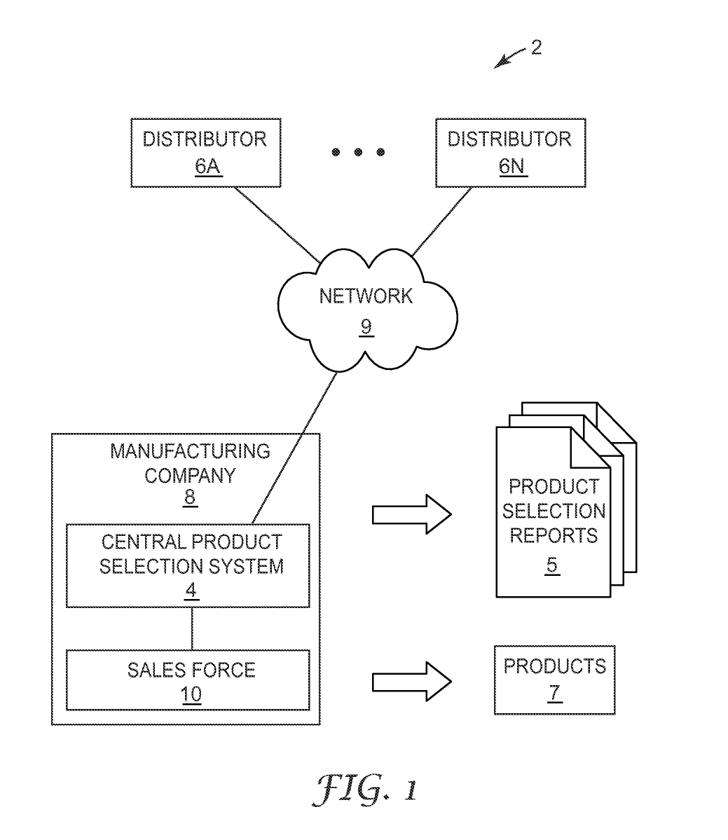

FIG. 1 is a block diagram illustrating a system 2 having a central product selection system 4 that operates consistent with the principles described herein. In general, users from manufacturing company 8's sales force 10 communicate with central product selection system 4 to request and review computer-generated electronic product selection reports 5 specific to distributor (or reseller) 6. Alternatively, authorized users of distributor 6 may interact with central product selection system 4 via a computer network 9 to request and review product selection reports 5 specific to distributor 6.

As described in further detail below, central product selection system 4 generate electronic product selection reports 5 to include information identifying a recommended set of products 7 that distributors 6 should purchase from manufacturing company 8 in order to increase or potentially maximize a return on investment from the products. Central product selection system 4 may automatically generate electronic product selection reports 5 to detail actions that the distributor 6 should perform to migrate from a current set of products 7 to the recommended set of products. For example, in certain embodiments, central product selection system 4 automatically (i.e., without substantial user assistance other than initiating the operation), generates electronic product selection reports 5 in a form that identifies particular products currently offered by the requesting one of distributors 6 that should be dropped, reduced or increased. In addition, electronic product selection reports 5 may identify particular products 7 not currently resold by the requesting one of distributors 6 that should be included in the distributor's offering. Moreover, central product selection system 4 may automatically generate the electronic product selection reports 5 to illustrate potential increased revenues that may be realized by the requesting one of distributors 6 as a result of the transition. In this manner, central product selection system 4 helps distributors 6 more easily identify the particular set of products 7 from manufacturing company 8 that will provide a optimized or otherwise increased return on investment. As used herein, an “optimized” product set is a relative term that means a product set designed to allow a specific to a distributor to achieve one or more specific goals, usually financially related. For example, for one distributor, it may mean maximizing that distributor's ROI on a product set purchased from manufacturing company 8 and resold by the distributor. For another distributor, it may mean maximizing market penetration or increasing revenue for the distributor, but not necessarily maximizing ROI. In any event, central product selection system 4 automatically and efficiently generates reports 5 in a manner that is tailored to the particular distributor and its specific goals based on the wide product line offered by manufacturing company 8.

Manufacturing company 8 is a large company that produces and sells thousands of products. Manufacturing company 8 has multiple business units, each selling thousands of products. Manufacturing company 8 has a plurality of manufacturing facilities.

As described in detail below, central product selection system 4 performs analytical techniques to identify the recommended set of products 7 (in some cases an optimal set) for the particular one of distributors 6 that initiated the request. Central product selection system 4 generates and outputs product selection reports 5 based on the analysis. Distributors 6 interact with central product selection system 4 via network 9 to view product selection reports 5 and ultimately determine a set of products 7 to purchase from manufacturing company 8.

Distributors 6 may include any organization that purchases and resells products 7 from manufacturing company 8. Distributors are also referred to as resellers. In one embodiment, resellers and distributors purchase goods or services, then sell the goods or services to subsequent consumers or other distributors and resellers. Central product selection system 4 may support distributors 6 of all sizes ranging from small local distributors to large international corporations. Central product selection system 4 securely controls access to product selection reports 5 as well as any other data or information produced to assist distributors 6 to ensure that the information for a given one of distributors 6 is not accessible by any other of distributors 6. Additionally, central product selection system 4 may read executable software instructions from a computer-readable medium (such as a hard drive, a CD-ROM, a DVD, or a computer memory), or may receive instructions from another source logically connected to computer, such as another networked computer.

Each of distributors 6 may have one or more authorized users that remotely interact with central product selection system 4 via network 9 to assist in report generation and product selection. In addition, individual salespersons from a sales force 10 of manufacturing company 8 may access central product selection system 4 on behalf of one or more of distributors 6. Thus, a user can be any authorized individual, such as a purchasing manager, or a sales person from manufacturing company 8.

By interacting with central product selection system 4, as described below, users request, view, and archive distributor-specific product selection reports to assist in selection of a set of products 7. This allows distributors 6 to more readily identify the particular set of products 7 from manufacturing company 8 that will provide an optimized or increased return on investment or otherwise achieve the one or more specific goals specified by each distributor. Upon review of the electronic material, a user may directly interact with central product selection system 4 to modify product orderings or communicate with sales force 6 to effect the recommendations generated by the central product selection system.

Each user typically interacts with a computing device suitable for communication and interaction with central product selection system 4 via network 9. For example, a user may use a workstation, personal computer, laptop computer, or even a personal digital assistant (PDA) such as a Palm™ organizer from Palm Inc. of Santa Clara, Calif. or Windows CE device. The communication device executes communication software, typically a web browser such as Internet Explorer™ from Microsoft Corporation of Redmond, Wash., in order to communicate with Central product selection system 4. Network 9 represents any communication link suitable for communicating data, such as a wide-area network, local area network, or a global computer network like the World Wide Web.

The service provider of central product selection system 4 may charge distributors 6 fees for use of the services. The service provider, in one embodiment, is manufacturing company 8. The service provider of central product selection system 4 may, for example, charge distributors 6 fees based on the number of accesses by users within distributors 6. In addition, the service provider of central product selection system 4 may charge subscription service fees or fees based on the number of product selection reports 5 produced and archived. Alternatively, central product selection system 4 may be offered as a value-add service coupled with other services or goods provided by manufacturing company 8. For example, services provided by central product selection system 4 may be offered to distributors 6 in conjunction with the sale of predetermined volumes of products 7.

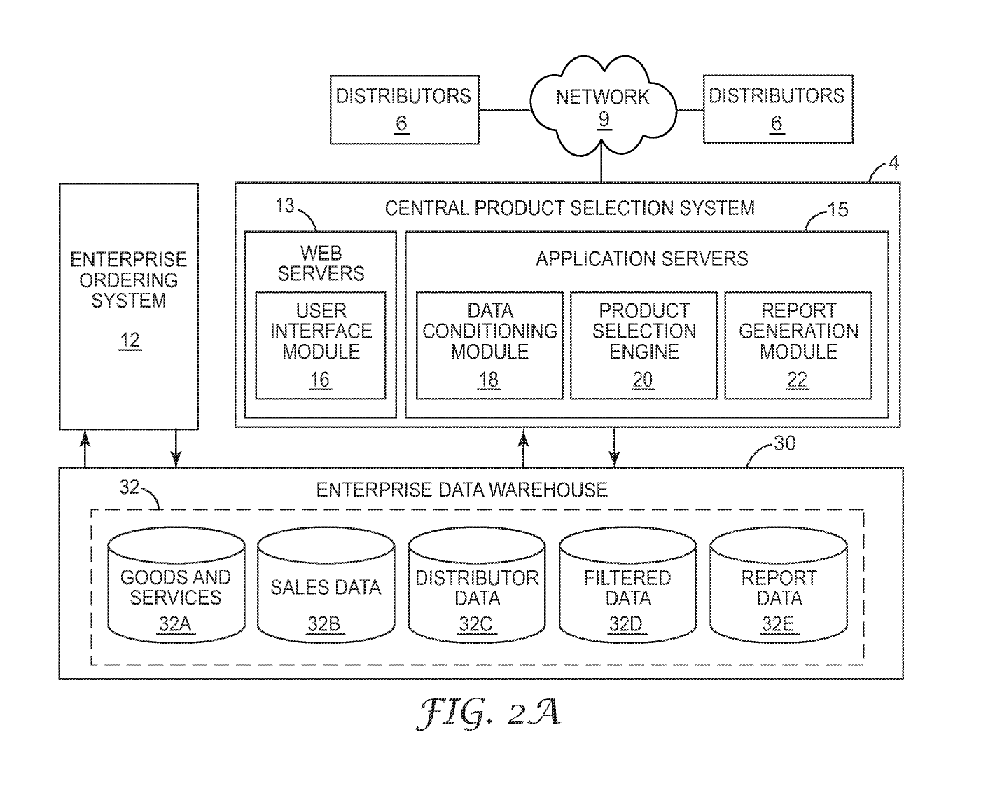

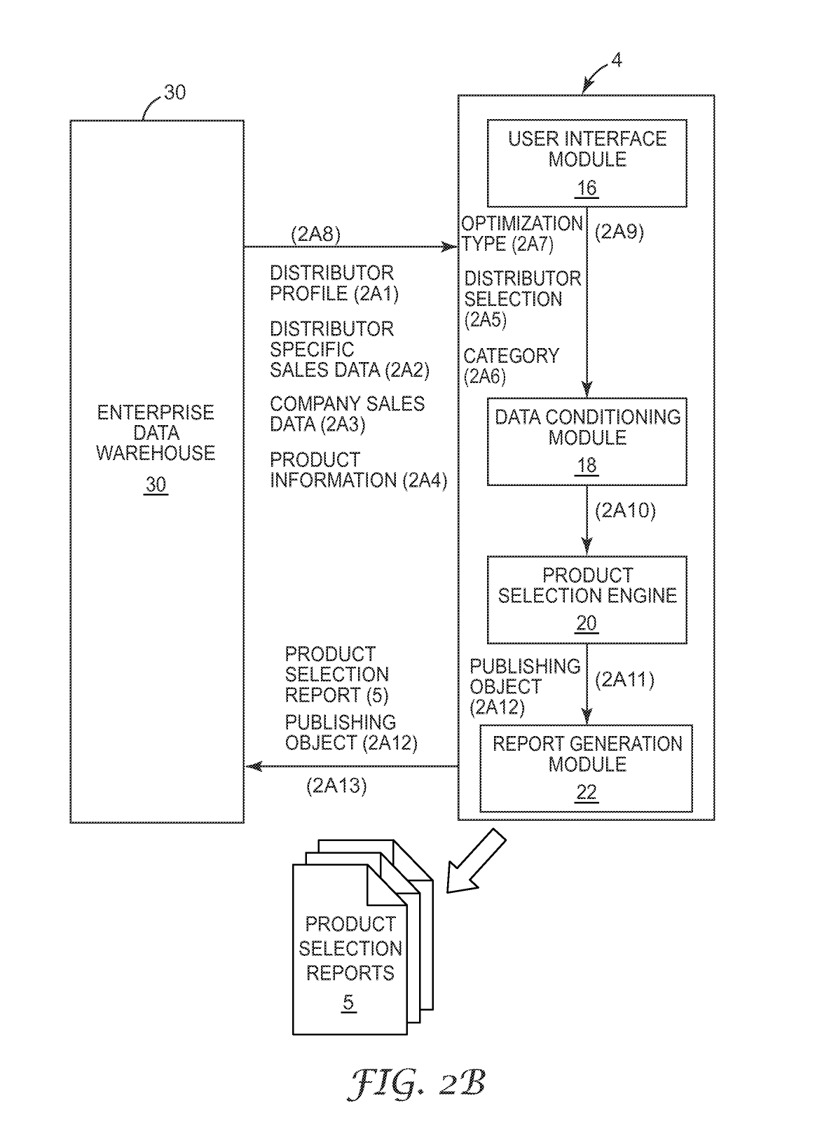

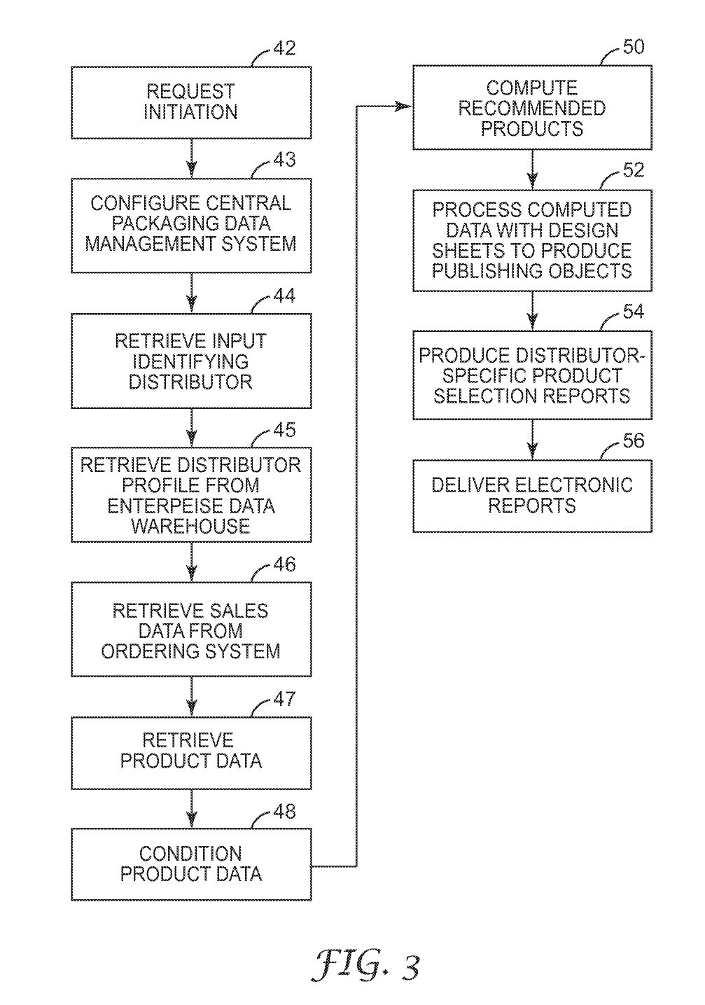

FIG. 2A is a block diagram illustrating an example embodiment of central product selection system 4 of FIG. 1. In the example of FIG. 2A, central product selection system 4 includes one or web servers 13 and application servers 15.

Web servers 13 provide an interface by which distributors 6 or manufacturing company 8's sales force 10 communicates with central product selection system 4 via network 9. In one configuration, web servers 13 execute web server software, such as Internet Information Server™ from Microsoft Corporation, of Redmond, Wash., or Apache™ from The Apache Software Foundation of Forest Hill, Md., for presenting a user interface 16, which can include Active Server Pages, or PHP Hypertext Preprocessor pages, or web pages written in hypertext markup language (HTML) or dynamic HTML, Active X modules, Java scripts, Java Applets, or other software modules.

In this example embodiment, web servers 13 and application servers 15 provide an operating environment for user interface module 16, data conditioning module 18, product selection engine 20 and report generation module 22, which are referred to collectively herein as the software modules of central product selection system 4. Although generally illustrated as “server side” software modules, portions of the software modules executing on central product selection system 4 could readily be implemented as “client-side” software modules executing on computing devices used by distributors 6 or manufacturing company 8's sales force 10. Portions of the software modules could be, for example, implemented as Active X modules executed by a web browser executing on the computing devices. Alternatively, portions of the software could be implemented as a non-web-based application which includes a stand-alone application.

The functionality of the individual software modules is described in further detail below. However, in general, the software modules of central product selection system 4 access an enterprise data warehouse 30 to interact with database servers 32, which provides a central data repository for manufacturing company 8. In this example, database servers 32 store goods and services data 32A, sales data 32B, distributor data 32C, filtered data 32D, and report data 32E. Each of these data repositories is described in further detail below. In general, data 32 may be stored in a variety of forms including data storage files, one or more database management systems (DBMS) executing on one or more database servers 40, or combinations thereof. The database management systems may be a relational (RDBMS), hierarchical (HDBMS), multidimensional (MDBMS), object oriented (ODBMS or OODBMS) or object relational (ORDBMS) database management system. Data 32 could, for example, be stored within a single relational database such as SQL Server from Microsoft Corporation of Redmond, Wash.

The term “enterprise” refers to a company that has a plurality of business units, each business unit offering for sale a plurality of products or services, at least some products or services of which are unique to the business unit and not sold by another of the enterprise's business units. A business unit may or may not be further comprised of a plurality of divisions. Some companies may not use the terms “enterprise” or “business unit” in referring to its own operations. In such cases, “enterprise” refers to the company, and “business unit” refers to the broadest organizational divisions between at least two groups that sell products or provide services to customers, at least some of the products or services not being provided by any other business unit. Divisions are organizational sub-classes of a business unit. In one embodiment, enterprise refers to large manufacturing companies, i.e. companies with annual revenue over $100 million, that buy raw materials, assemble or transform the raw materials into products, then sell the products.

The term “enterprise-wide”, when used in the context of a system, database, or other information technology infrastructure, refers to the breadth of the system, database, or other infrastructure's implementation. Specifically, it means that substantially all business units, but not necessarily each division within a business unit, uses the system, database, or other infrastructure.

Enterprise ordering system 12 facilitates receipt and processing of orders from manufacturing company 8's resellers. To do this, it interacts with the various systems in enterprise data warehouse 30. For example, enterprise ordering system 12 may pull current listings of products, inventory levels, lead times, and various reseller data from enterprise data warehouse 30, and allow an order to be placed for goods or services provided by manufacturing company 8.

Goods and services data 32A provides data describing and identifying types of goods and/or services provided by manufacturing company 8. For example, goods and services data 32A includes a variety of data that classifies, categorizes, and uniquely identifies substantially all of the types of goods and services offered by manufacturing company 8. Example data includes data defining product categories and descriptions for the categories, data defining attributes for categories of products and individual types of products, global sales codes (GSCs) or universal product codes (UPCs) or other identifiers for each type of product or service, and product descriptions and marketing information for each of the types of products or services. Manufacturing company 8's goods and services may also be called its offerings.

Sales data 32B represents enterprise-wide sales data associated with the products and services sold by manufacturing company 8. More specifically, sales data 32B represents a central repository of scheduled, current, and past sales transactions processed and recorded by enterprise ordering system 12. Enterprise ordering system 12 may be a large-scale enterprise computer system or a distributed collection of systems for processing orders and managing accounts payable and inventories within manufacturing company 8.

Distributor data 32C represents data that defines each of distributors 6 subscribing to the services of central product selection system 4. In particular, distributor data 32C contains distributor profiles, which are a collection of information specific to each distributor, and may include for example data assigning a name and an identifier to each of distributors 6, as well as data specifying a variety of characteristics that may influence the set of recommended products for each of the distributors. Example data includes data defining the particular geographic location of the respective distributor 6, economic and market conditions at that particular geographic location or surrounding region, specific customers that distributor 6 may serve, demographics of customers that distributor 6 serves, seasonal influences experienced at the locations distributor 6 serves, and various sales-related reports and statistics regarding the distributor generated from transaction detail stored in sales data 32B. For example, total sales to the distributor may be stored in the distributor profile, even though the base data for the calculation comes from sales data 32B. Further, the distributor profile may include figures and statistics specific to the individual distributor that come from a combination of other information sources within enterprise data warehouse 30. For example, the distributor profile may include a listing of the largest orders manufacturing company 8 has received from the distributor (from sales data 32B), by UPC number (from goods and services database 32A).

Filtered data 32D contains a subset of information from goods and services data 32A and sales data 32B that is useful or required for product selection engine 20 to analyze any particular distributor profile and produce an optimized product selection recommendation. In one embodiment, filtered data 32D is a collection of pre-defined queries, or views, programmed into the goods and services database 32A or sales data 32B. In such an embodiment, filtered data 32D is not a database unto itself, but is instead a layer of abstraction between enterprise data warehouse 30 and central product selection system 4. In another embodiment, application servers 15 may interact directly with goods and services database 32A and sales data 32B to retrieve requisite information (thus obviating filtered data 32D), but within a large manufacturing facility the size and scale of enterprise-wide databases (such as goods and serviced database 32A and sales database 32B), coupled with the broad, complicated requests for information that may come from application servers 15 in generating a product selection report 5 for a distributor 6, may create performance issues. In another embodiment, filtered data 32D is an actual intermediary database sitting between central product selection system 4 and goods and services database 32A and sales data 32B. The best embodiment for a given enterprise will depend on the performance of the goods and services database 32A and sales data 32B, as well as performance requirements for the central product selection system 4. Moreover, the best embodiment may be a combination of the above-mentioned possible embodiments (they are not mutually exclusive and may be practiced in combination with each other).

Filtered data 32D may not contain all information required by application servers 15 in creating a product selection report 5, but is designed to contain most of it, and in so doing reduce the load on the databases that house goods and service information, and sales data, and improve performance of the central product selection system.

Report data 32E contains output reports in electronic format (such as the Portable Document Format™ (PDF) from Adobe Corporation of San Jose, Calif.) and underlying report data from central product selection system 4, particularly from report generation module 22. For example, if a product selection report 5 was automatically produced for Distributor A, both the final report and various information upon which that report was based may be archived in report data 32E. This allows a user to view past product selection reports 5 produced for a given distributor, or various reports run during a time period, via user interface 16.

User interface module 16 allows a user, often within the sales force 10 or a user from distributor 6 (but could be any authorized to use the system), to select a distributor 6 for which the user would like a product selection report 5 generated, and additionally select the one or more goals of the product optimization. For example, a user could select Distributor B, with the goal being to increase revenue for that particular distributor. Alternatively, user could indicate that the optimization goal for Distributor B is to increase return on investment as a percent, or as a dollar amount.

Generally viewed, application server 15 includes software modules that comprise the analytic engine of the central product selection system. The first component of this analytic engine is the data conditioning module 16, which interacts with enterprise data warehouse 30 to retrieve all requisite information necessary for product selection engine 20 to assemble product selection report 5.

Product selection engine 20 may determine that various other information, not initially provided by data conditioning module 18, is necessary or useful in generating the optimized product selection report 5. Product selection engine 20 will request such data from data conditioning module 18, at which point data conditioning module 18 will determine if such data exists within filtered data 32D. If it does, it will retrieve said data and provide it to product selection engine 20. If the data is not present in filtered data 32D, data conditioning module 18 may make queries to the goods and services database 32A or sales data 32B directly to assemble such data. If, for whatever reason, data conditioning module 18 is not successful in retrieving the data requested by product selection engine 20, data conditioning module 18 will signal such to product selection engine 20. The failure is not fatal to the analysis that is done within product selection engine 20 as the initial dataset retrieved by data conditioning module 18 has already been determined to be sufficient for product selection engine 20 to develop a set of products. Thus, if the request from product selection engine 20 is denied or unsuccessful, product selection engine 20 merely proceeds with the data that is available.

Once product selection engine 20 has developed an optimized set of products for a given distributor (a process which is described in detail below), the resulting set of information is passed to report data 32E for presentation and archiving. Information saved in report data 32E may then be analyzed to later see, for example, whether a given product selection report 5 was acted upon by distributor 6A, and whether and to what extent the optimization goal was achieved. Report data 32E may be used to examine the efficacy of the central product selection system as a whole, and thus improve the product selection algorithms used within product selection engine 20.

Report generation module 22 interacts with application servers 15 and web servers 13 to generate electronic product selection reports 5, as described in detail below. As described above, report generation module 22 may generate product selection reports 5 in a form viewable via user interface 16 (such as HTML or PDF). It may also generate reports suitable for printing on a hard copy, or suitable for emailing as an attachment to an email message. The report generation module 22 may interact additionally with goods and services database 32A to develop more detailed information about the suggested product offering. For example, report generation module 22 may retrieve product ordering codes, lead times, delivery schedules, or other data that is generally useful for a distributor to have when making a decision concerning placing an order. Once the report is complete, report generation module archives it in report data 32E.

FIG. 2B is an example flowchart showing high-level information flows among and between the various software modules of central product selection system 4 and enterprise data warehouse 30. This flowchart is for high-level example purposes only, and one skilled in the art will recognize that there may be other, ancillary information flows to facilitate those presented herein.

User interface module 16 facilitates selection of various information, and passes (indicated by arrow 2A9 on FIG. 2B) parameters to data conditioning module 18, including a distributor selection 2A5 (i.e., the distributor for which the product selection report 5 is intended), and a category selection 2A6 (category is discussed in detail below, but can be broadly viewed as one or more product types to which the report will be targeted). In one embodiment, the user may select a plurality of categories the reseller participates in, or is interested in participating. For the purposes of illustration, however, examples discussed herein will generally be focused on reports for a single category.

In response, data conditioning module 18 retrieves and assembles relevant information from enterprise data warehouse 30 (2A8). In one embodiment, this information is composed of four general data sets.

The first data set is the distributor profile for the selected distributor from distributor data 32C for which a product selection report 5 has been requested (2A1). Data conditioning module 18 checks this data for errors and inconsistencies, then acquires the remaining three data sets from filtered data 32D it has determined will be used by product selection engine 20 for computing an optimized set of products for the distributor.

The second data set is historic sales information specific to the distributor for which product selection report 5 has been requested (2A2). This information comprises the distributor's 12-month rolling purchase totals at the individual SKU level for all SKUs within a product category carried by the distributor. Product categories, in one embodiment, are broad product classifications, such as abrasives, tapes, adhesives, safety, commercial care, electrical, or office products. These categories are for example purposes only; specific product categories would be chosen based on business need and the types of products manufacturing company 8 deals in. Product selection reports 5 will be specific to at least one product category selected via user interface module 16. For example, if tape is the selected category for Distributor X, all SKUs within that category are first identified. There may, for example, be 1,000 such SKUs, defining various types of tape products produced by manufacturing company 8. Out of these 1,000, usually only a small subset will be carried by any given distributor—for example, only 10 of the 1,000 tape products may be carried by distributor 6. For each of these 10 SKUs, rolling 12-month sales information concerning that distributor's purchases is assembled by data conditioning module 18. Distributor-specific rolling 12-month total sales information (for all categories carried by distributor) is also requested, such that the relative importance of the selected category may be analyzed.

The third data set retrieved by data conditioning module 18 is sales information which is general to manufacturing company 8, and not specific to distributor (2A3). For example, this information includes manufacturing company 8's total sales of all SKUs within the selected category. Continuing the example introduced above, this information would include, at manufacturer 8's level, total rolling 12-month sales figures by SKU for each of the 1,000 SKUs contained within the tape category.

The fourth data set retrieved by data conditioning module 18 is product-specific information relevant to the SKUs in the selected category (2A4). It includes, for each SKU in the selected category, whatever information is available concerning that product. For example, it may include UPC numbers, a marketplace formal name (also referred to as the corporate standard product name), product specifications (color, dimension, size, grade, case quantity, pricing information, units per case, etc.), and a digital image of the product.

Data conditioning module 18 checks these four data sets for completeness and errors. Programmed into data conditioning module 18 is a rule set that defines the data required by product selection engine 20. If there are issues with the data such that it is incomplete or otherwise unsuitable for further processing, data conditioning module 18 will communicate an appropriate message back to user interface 16. Only when data conditioning module 18 has determined the data is sufficient and adequate for further processing will the data received from enterprise data warehouse 30 (2A8) and user interface module 16 (2A9) be passed to product selection engine 20 (2A10).

Product selection engine 20 processes the data in a manner described in detail below, then passes publishing object 2A12 to report generation module 22. The publishing object is discussed in further detail below. Report generation module creates an electronic version of product selection report 5, then passes the report and the publishing object back to the enterprise data warehouse 30 for archiving, typically within report data 32E (2A13).

FIG. 3 is a flowchart illustrating an example operation of central product selection system 4 producing a product selection report 5. The process starts with a request (43). The request would ideally be received via web servers 13 running user interface module 16. The user interface module 16 may present a listing of a plurality of distributors, or a subset of distributors for whom a product selection report 5 is particularly useful. User interface module 16 may keep distributor data local, or ideally it is pulled from distributor data 32C, or assembled from other data sources in enterprise data warehouse 30. User interface module 16 may allow a user to find a particular distributor 6 in several ways. For example, user interface module 16 may pre-populate a pull-down menu with various distributors, or it may allow the user to enter a portion of distributor 6's name. Other searching possibilities also exist, such as searching based on geographic location (by state, city, zip code, etc.). User interface module 16 ultimately facilitates the selection of one or more distributors (44).

User interface 16 also facilitates the selection of other attributes and report criteria. For example, if there were multiple types of optimization reports suitable for a given distributor, user interface module 16 would gather such information at this time. The product category for which the product selection report is to be generated is also solicited at this point. A user selects the product category from a list pre-populated with all product categories that the distributor deals in, and additionally may be selected from an alternative list of categories that the distributor does not deal within currently, but is considering.

With at least one distributor specified, control is passed to application servers 15, which will facilitate the actual generation of product selection report 5 for the specified distributor. This starts with data conditioning module 18 retrieving the distributor profile from distributor data 32C (45). The distributor profile will include a variety of information concerning the distributor, including geographic location, the industries served by the distributor, and may also include other distributors that have been identified as similar based on some attribute such as sales activity, customer base, or geographic location. Once received, data conditioning module 18 checks the distributor profile for completeness, and then determines what other data is either required or will be useful for the product selection engine 20 to optimally choose a set of products. Data conditioning module 18 then pulls additional sales data from filtered data 32D that is both specific to the distributor, and general to the corporation (46), as described in greater detail with respect to FIG. 2B. Data conditioning module 18 applies various filters to the data to eliminate data sets that will have no bearing on product selection engine 20, or will not be interpreted correctly by products selection engine 20. In other words, data conditioning module 18 both pulls the requisite data needed by application servers 15, but in so doing it also standardizes it such that a consistent set of data is presented to product selection engine 20. Data conditioning module 18 may determine that various data are not properly available in filtered data 32D, or that the data available in filtered data 32D is not current, or otherwise sub-optimal. It may determine this if, for example, the initial request for the application servers 15 described above with respect to step 43 is beyond basic—for example if optimization is requested for a particularly obscure distributor with respect to a particularly obscure set of products. This is because filtered data 32D does not contain all data that will ever be required or useful for application servers 15 to determine an optimized product selection report. Rather, filtered data 32D contains most information that will be required or useful, or would otherwise be inefficient to get if going directly against other enterprise databases as for example the goods and services database 32A or sales data 32B. If, for whatever reason, data conditioning module 18 has determined filtered data 32D is less than sufficient or optimal, data conditioning module may attempt to retrieve data directly from other databases within enterprise data warehouse 30, particularly, for example, goods and services database 32A, or sales data 32B.

Having already acquired distributor profiles (45) and various sales data (46), data conditioning module next retrieves product-specific data (47) from filtered data 32D. Product data is data that more specifically identifies the actual goods behind the sales data retrieved in step 45, for both the specific distributor and the corporation as a whole. It is described in greater detail with respect to FIG. 2B. Data conditioning module 18 next conditions the product data (48) by determining what will be useful and relevant based on the choices made in the initial request (43), and otherwise prepares it for handoff to product selection engine 20 in a consistent format.

At this point, data conditioning module 18 has acquired all information it has determined is required, and possibly some information deemed useful but not required, for product selection engine 20 to produce a distributor-specific optimized product set. Recommended products are computed based on these inputs (50) via the product selection engine 20, as is described in detail below. Once recommended SKUs have been determined, product data information is assembled into the recommended product selection set (52), in order to represent the SKUs in a more human-readable format on the final report. The information is assembled into publishing object 2A12. At this point publishing object 2A12 may contain product information at several levels of detail, some of which are redundant with one another. A resulting report likely will not need more than one of these detail levels, but all are provided such that report generation module 22 may determine by its own rule set what level of detail is appropriate for the final report.

The publishing object is next output, or packed, into an intermediary transfer package. The publishing object is in one embodiment defined using extensible markup language (XML), but other data description languages or alternative techniques could be used to describe the data such that it can be disassembled post-transfer, ready and available for the report generation module 22 and report data 32E. Further, it is not necessary that the data be packed; rather, the data could merely be transferred in native form, through database calls for example.

With the XML package populated and complete, it is passed to report generation module 22. Report generation module 22 unpacks the XML package and stores it in report data 32E for archiving purposes. Alternatively, the XML package may itself be saved as a flat file, without being unpacked. Report generation module 22 then iterates through the unpacked XML package and inspects data elements.

Report generation module 22 then uses a template, based on the selections made by user, and populates data elements from XML package and puts these into a report template (54). Report generation module may create a PDF file, and provide this to user interface module 16, to be presented to user. Alternatively, report generation module may produce HTML files, or word documents, as possibly specified by user via user interface module 16. Report generation module 22 may also format reports for various end-uses, such as placing an order (in which case report generation module 22 would print out an order form, to be signed by distributor and sent to enterprise ordering system 12). Whatever the form or format, report generation module produces the final product selection report and delivers it to user (56), via user interface module 16, or, for example, via email.

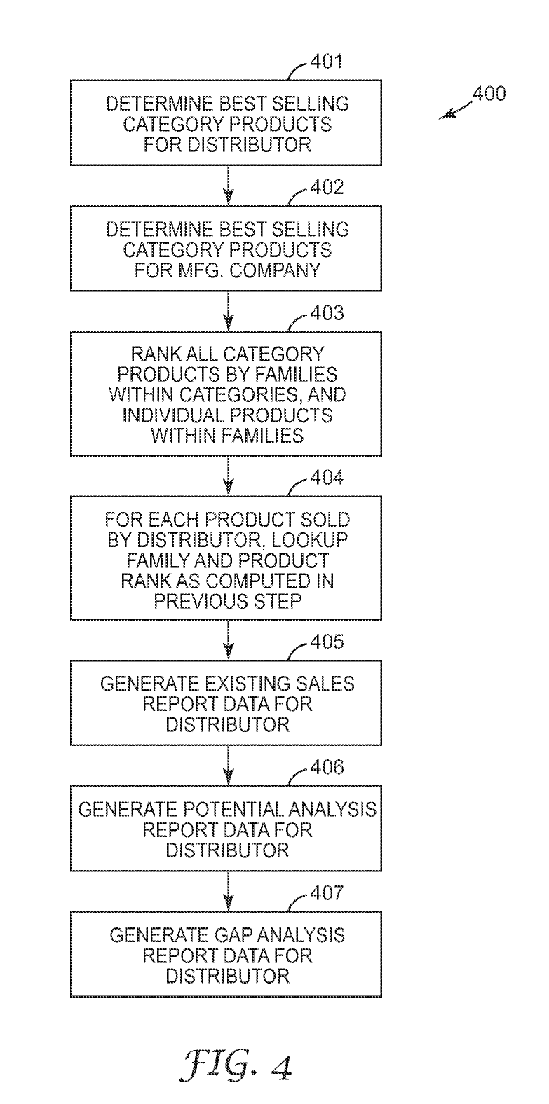

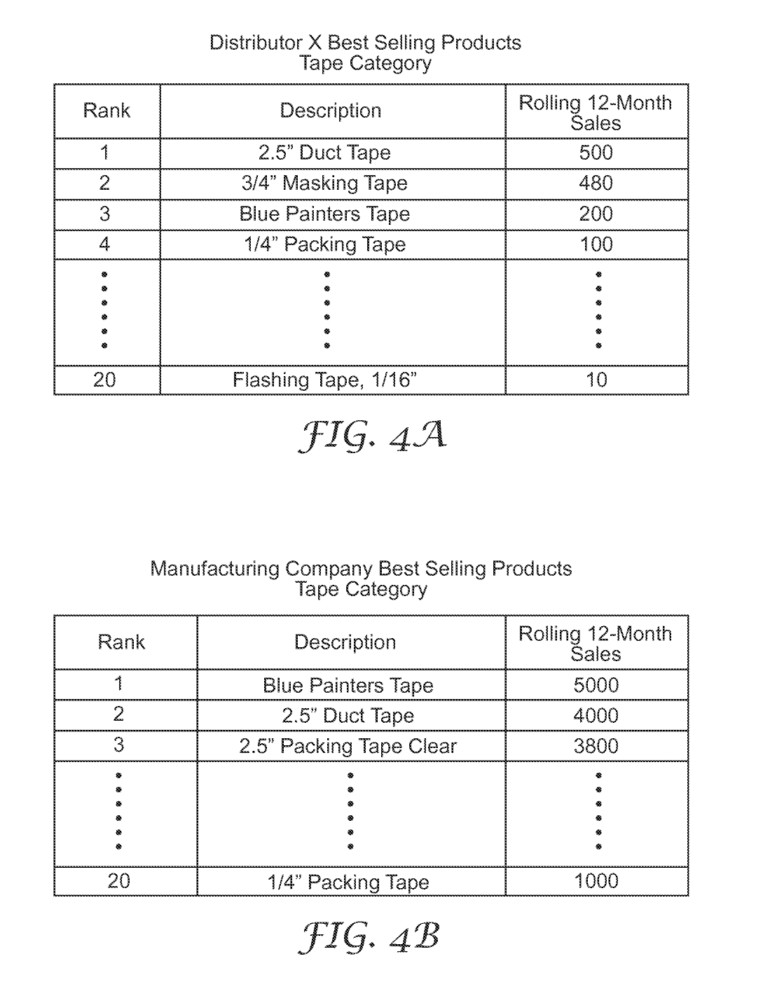

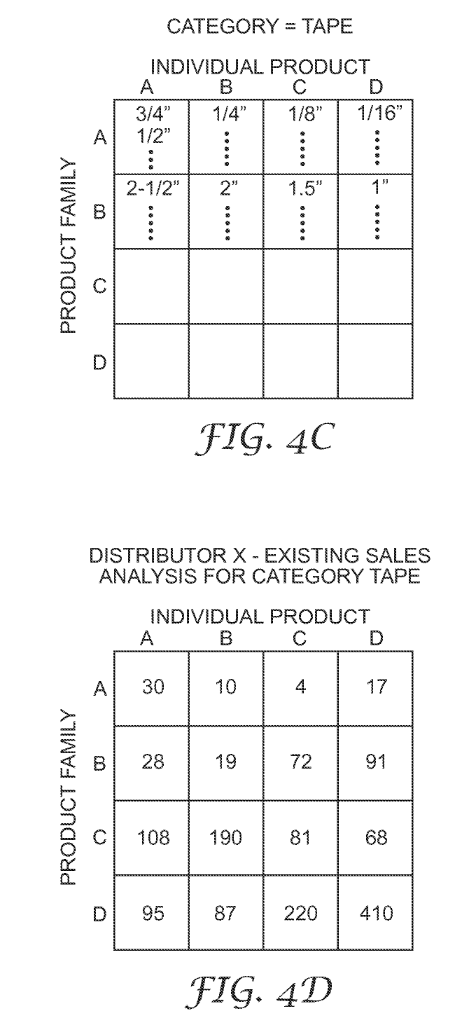

FIG. 4 is a flowchart 400 that illustrates example operation of product selection engine 20 when processing inputs from data conditioning module 18 and producing recommended products to be included in product selection reports 5.

Product selection engine 20 starts by determining the best selling category products for the given distributor (401). Continuing with the tape category example introduced earlier, in this step, product selection engine 20 ranks in descending order the rolling 12-month sales for each product sold by the distributor in the past year that is included in the tape category. The top N (e.g., 20) products are kept, and the remaining dataset discarded. If distributor 6 has sold fewer than 20 items within the tape category in the previous year, all products sold within that category will be included in the top 20 listing. This resulting dataset will hereinafter be referred to as “Best Selling Category Products by Distributor.” For example, FIG. 4A shows an exemplary representation of the resulting data from this step.

Next, product selection engine 20 ranks all products within the category of interest for all of manufacturing company 8 (402). This is done similarly the manner in which Category Products by Distributor was determined earlier. For each individual product within a category, manufacturing company 8's rolling 12-month sales are determined, then the products ranked by this figure in descending order. The top N (e.g., 20) items are kept, the remaining items discarded. This resulting dataset will hereinafter be referred to as “Manufacturer's Best Selling Category Products.” FIG. 4B shows an exemplary representation of the resulting data from this step.

Next, product selection engine 20 ranks all category products sold by manufacturing company 8 by sales according to product family within the category, and individual products within the families (403). A product family is a subset of a product category, and more particularly defines the type of product that is involved. For example, if the product category is tape, the various product families might include masking tapes, packaging tapes, duct tapes, bumpers, fasteners, double-coated tapes, filament tapes, foam tapes, safety tapes, specialty tapes, and electrical tapes. Each of these families likely has many products within it. For example, the masking tape family may include ¾″ masking tape, ½″ masking tape, ¼″ masking tape, and so forth. Additionally, continuing with the tape example, for each width there may be additional products representing various tape lengths.

The family ranking is accomplished by ranking product families in descending order, by rolling 12-month sales totals. The category totals are determined by summing the rolling 12-month sales totals for each of the products that make up the family. If the category were tape, and the family were masking tape, the rolling 12-month total for each product of type masking tape would be added. A similar calculation would then be performed for all other families within the category, such as packaging tape, duct tape, and electrical tape. The total of these families' rolling 12-month totals should equal the rolling 12-month sales for the category. Each family is then assigned a ranking, either A, B, C, or D, depending on the total sales of that family relative to the total sales of the category, as shown in the following exemplary Table 1:

TABLE 1

| Rank | Cumulative Percent of Sales |
|---|---|
| A | 40 |
| B | 80 |
| C | 95 |
| D | 100 |

The family with the highest sales amount is given a rank of A. If it does not account for 40% of the category sales, then the next largest family is also given a rank of A. If those combined do not account for 40% of category sales, then the 3^{rd} largest family is given a rank of A, and so forth. When the combined sales amounts for the largest families exceeds the cutoff point for As, then Bs are assigned in the same manner as used with respect to As. When the combined sales for the largest families exceeds the cutoff point for Bs, then Cs and Ds are assigned likewise. In one embodiment, there will be at least one family with a rank of A.

Not all ranks must be assigned. For example, if there are three families, which each account for ⅓ of the category's total rolling 12-month sales, the first group would be given an A ranking. The second family would be also given an A ranking because the previous first family did not exceed the 40% threshold. The final product category will be ranked as B, since the previous two account for less than 80% of the category's sales (they account for ˜67% of the sales).

Finally, the individual products within the families are ranked in the same manner as just explained with respect to the families within the categories. Within each family, products are ranked in descending order by total rolling 12-month sales. The product with the highest sales amount is given a rank of A. If it does not account for 40% of the category sales, then the next largest product is also given a rank of A. If those combined do not account for 40% of family sales, then the 3^{rd} largest product is given a rank of A, and so forth. When the combined sales amounts for the largest products exceeds the cutoff point for As, then Bs are assigned in the same manner as used with respect to As. When the combined sales for the largest products exceed the cutoff point for Bs, then Cs and Ds are assigned likewise. At the conclusion of this step, every product in the category will have two letter rankings associated with it.

This resulting dataset will hereinafter be referred to as “Manufacturer's Category by Family and Family by Product Ranking.” FIG. 4C is a representation of the relationship represented by Manufacturer's Category by Family and Family by Product Ranking. If product families are such that only one product family is within category A, say for example masking tape, and only one product family is within category B, say for example electrical tape, one can see that within the masking tape family (A), manufacturing company 8's best selling products are in cell AA and include ¾″ masking tape, ½″ masking tape, and so forth.

Next, product selection engine 20 accesses and retrieves each product sold by distributor 6 within the category from the Manufacturer's Category by Family and Family by Product Ranking dataset (404). This may be accomplished, if using relational databases, by an inner join operation. In this manner, each category product carried by a distributor is associated with the ranking AA, AB, BA, etc. ranking. If the product does not have a ranking, if for example it was purchased by distributor and discontinued by manufacturing company 8 over 12 months ago, or if it does not meet some pre-determined sales volume threshold set by the user (for example, a total sales amount under which user is not concerned), then the product is given a ranking of XX and not further considered. All products sold by the distributor within the category of interest will have a ranking after this step.

The dataset resulting from this operation will hereinafter be referred to as “Manufacturer's Category by Family and Family by Product Ranking for Distributor's Products.” The resulting relationship represented in this dataset will be similar to that as in FIG. 4C, except it will only apply to the products distributor carries within a category (whereas FIG. 4C applies to everything manufacturer 8 sells within that category).

Next, product selection engine 20 generates data for the first of three reports (the generation of which is represented in 405, 406, and 407 respectively), the first being existing sales report data for the distributor. “Reports,” as the term is used with respect to data processing within product selection engine 20, refers to the underlying, computed data which may be formatted and sent to report generation engine 22. It does not mean a finalized report. The data used in this report is Manufacturer's Category by Family and Family by Product Ranking for Distributor's Products. Each product distributor 6 carries is put into a bucket represented by the various 16 combinations of family ranking within category (A-D), and product ranking within family (A-D) (404). FIG. 4D is an example of what such a report might look like if represented in a matrix (405). One can see that distributor 6, in the last 12 months, is selling 10 products in product family ranking A, and individual product ranking B.

Next, report data is generated to determine the distributor's potential with respect to products the distributor already carries (406). This number is a sales goal for distributor 6 to strive for and designed to be within reach for the distributor. In one embodiment it is computed as follows:

The process starts with the set of all products sold within the category by distributor 6 in the previous 12 months. This set is compared with all products sold by manufacturing company 8 within the previous 12 months, and the matching products form the Common Product Subset. (Note that it is possible for products to be in the distributor history, but not in the manufacturing company 8's history because, as noted earlier, have been purchased by distributor and discontinued by manufacturing company 8 over 12 months earlier, or the sales data may not meet some internal threshold of interest.)

Next, both the distributor 6's and manufacturing company 8's rolling 12-month sales figures are tallied for each product in the Common Product Subset. These numbers are also summed, such that one can see that distributor 6's total sales for the Common Product Subset were X, whereas manufacturing company 8's total sales were Y. This allows a distributor/manufacturer ratio for the category to be computed by dividing X by Y. For each product in the Common Product Subset, a potential sales number is then calculated by multiplying the distributor/manufacturer ratio by manufacturing company 8's total rolling 12-month sales for a given product. If distributor 6 sold less than the resulting potential sales number, the resulting potential sales number is the goal. If distributor 6 sold more than the target number, the target goal is the potential sales number multiplied by two. In the end, there will always be a goal number that is larger than the existing sales totals for the distributor.

As an example, assume manufacturing company 8 had sales of products P1, P2, P3, P4 in the amounts of $1000, $2000, $3000, and $4000 respectively. Assume distributor 6's sales of the same products were $75, $75, and $450 for P1, P2, and P3 respectively. P4 is not carried by distributor 6. The Common Product Subset is P1, P2, and P3, but not P4. The distributor 6/manufacturer 8 ratio is computed by adding distributor 6's sales of P1, P2, and P3 ($75, $75, $450), which equals $600, and dividing by manufacturing company 8's total sales of P1, P2, and P3 ($1000, $2000, $3000), which equals $6000. Thus, the distributor 6/ manufacturer 8 ratio is 0.10. The initial goals for distributor 6 are then:

P1: $1000×0.10=$100,

P2: $2000×0.10=$200, and

P3: $3000×0.10=$300

Note that for P1, the current sales are $75, and the potential is $100, so the goal is $100. But for P3, the current sales by distributor 6 are $450, and the potential is $300. In this case, the potential is doubled, and the goal becomes $600.

Finally, product selection engine 20 prepares a gap analysis report data for the distributor (407). The gap analysis report identifies the better selling manufacturing company 8 products that the distributor is not currently selling and computes how much revenue could be gained by distributor 6 from selling the product. The gap analysis is computed as follows:

First, the ratio is calculated in the same way as in 406. The same ratio may in fact be used if it has already been calculated, with two caveats. First, if the distributor is not selling any products within the category or if it is negative (returns within a category), a ratio of 0.01 is substituted for the actual ratio. Second, if there are fewer than 50 products in common between distributor and division, and the ratio is greater than 0.04 or the total sales in the category for a distributor is less than $10,000, the ratio is likewise set to 0.01. This addresses the anomalous situation that arises when a given distributor 6 purchases few items but is largely responsible for most of the sales of those items, resulting is an unacceptably high ratio

Next, a set of Candidate Products offered by manufacturing company 8 is determined. This is done by dropping all products with a ranking lower than CC (since a goal may be to push higher volume products). For each product ranked CC or better, a comparison is made to the product set currently carried by distributor 6. Matched products are eliminated, and the resulting data set contains candidate products that distributor is not selling, and hereinafter is called Suggested Products. For each Suggested Product, the ratio calculated in the preceding paragraph is multiplied by manufacturing company 8's rolling 12-month product sales, resulting in a dollar value Gap Calculation.

Next a final set of rules is applied to the Gap Calculation to make sure the recommendations are on the whole reasonable. It may happen, for example, that Gap Calculation for a given product is disproportionately high relative to the total distributor sales. If this is so, various coefficients are applied that make the number altogether reasonable. These numbers vary from industry to industry.

If the Gap Calculation for a product is less than $1000 or some other threshold amount, the Suggested Product is removed from the Suggested Products list, so as to avoid recommending products with small dollar amounts.

The resulting dataset is a list of Suggested Products and a Gap Calculation for each Suggested Product that gives a sense of product potential if the product is carried by distributor 6.

As an example, assume manufacturing company 8 had sales of products P1, P2, P3, P4 in the amounts of $1000, $2000, $3000, and $4000 respectively. Assume distributor's sales of the same products were $75 and $75 for P1 and P2 respectively. P3 and P4 are not carried by distributor 6. The Candidate Products are P3 and P4. If they rank CC or better, they become Suggested Products (in this example, they both do). The distributor 6/manufacturer 8 ratio is computed by adding distributor's sales of P1, P2, and P3 ($75, $75), which equals $150, and dividing by manufacturing company 8's total sales of P1, P2, and P3 ($1000, $2000, $3000), which equals $6000. Thus, the distributor 6/manufacturer 8 ratio is 0.025.

The initial goals for distributor 6 are then:

P3: $3000×0.025=$75

P4: $4000×0.025=$100

In summary, in one embodiment, outputs from product selection engine 20, and dataflow 400, are the following, along with the step they are generated in.
1) Best selling products within category by distributor 6, “Best Selling Category Products by Distributor” (401).
2) Best selling products within category by manufacturer 8, “Manufacturer's Best Selling Category Products” (402).
3) Manufacturer's ranking of products within category, “Manufacturer's Category by Family and Family by Product Ranking” (403)
4) Existing sales report data (404 and 405).
5) Potential analysis report data (406).
6) Suggested Products and Gap analysis report data (407).
These outputs are assembled into an XML publishing object along with distributor profile data and sent to report generation module 22.

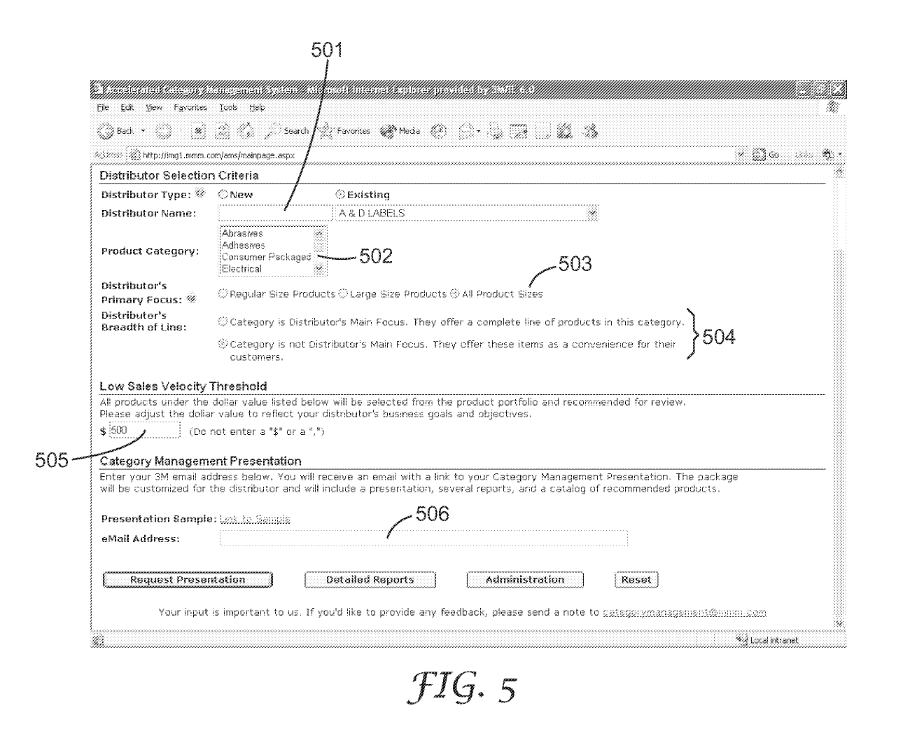

FIG. 5 is a sample screenshot of user interface module 16 showing a basic set of selections a sales force 10 user would make in requesting central product selection system 4 to generate a product selection report 5 for distributor 6. Included within FIG. 5 is an input area 501 for providing parameters to lookup a specific distributor 6 by name. Menu 502 shows the product categories to which the report should be drawn. Selection button 503 allows a user to specify the types of physical product sizes distributor 6 deals in, and consequently the type of report desired. Generally, and in one embodiment, distributor 6's focus is on regular sized products if they sell into maintenance and repair type industries. For example, tape sold into this market is masking tape held by a worker. This same distributor 6 may not cater to production-type operations, where masking tape is sold by a jumbo roll, to be further processed and used perhaps in other products. Selection button 503 is a simple means of limiting the scope of potential products to ones that are more relevant, and could be any set of criteria that will make analysis more relevant by distributor 6 by limiting manufacturing company 8's potential product set. Selection area 504 provides another mechanism for the user to specify additional information about the type of distributor 6, and consequently how the report should be focused. In this case, the information sought concerns distributor 6's breadth of products within the category. If the selected product category is distributor 6's main focus, product recommendations will be of range CC or better. If the category is not distributor 6's main focus, product recommendation reports will focus on categories BB or better (a narrower subset of products, since the category is not the distributor's main focus). Input area 505 allows the user to input a low sales velocity threshold number. Recommended products expected to have sales below this number are, in one embodiment, dropped from the report, so as to focus on higher value product lines. Finally, input area 506 allows the user to enter an email address to which the electronic report will be delivered.

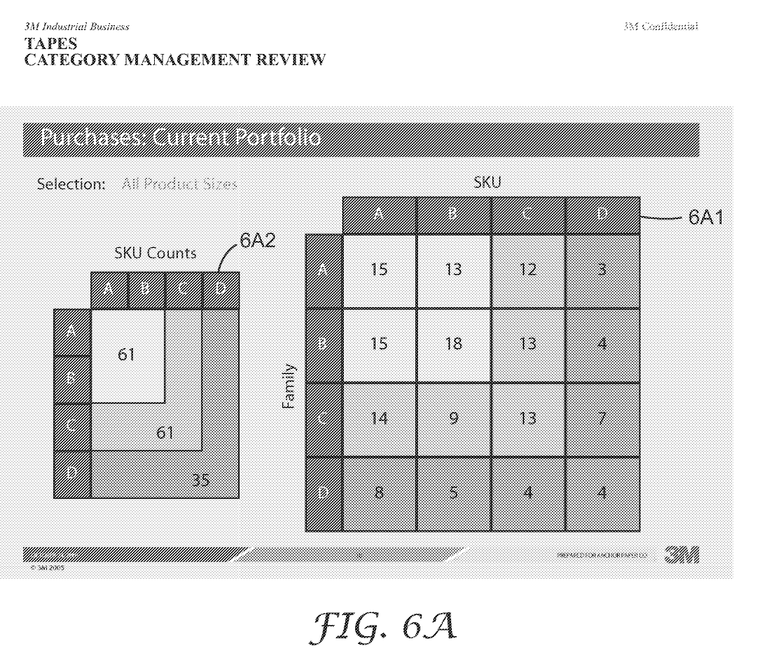

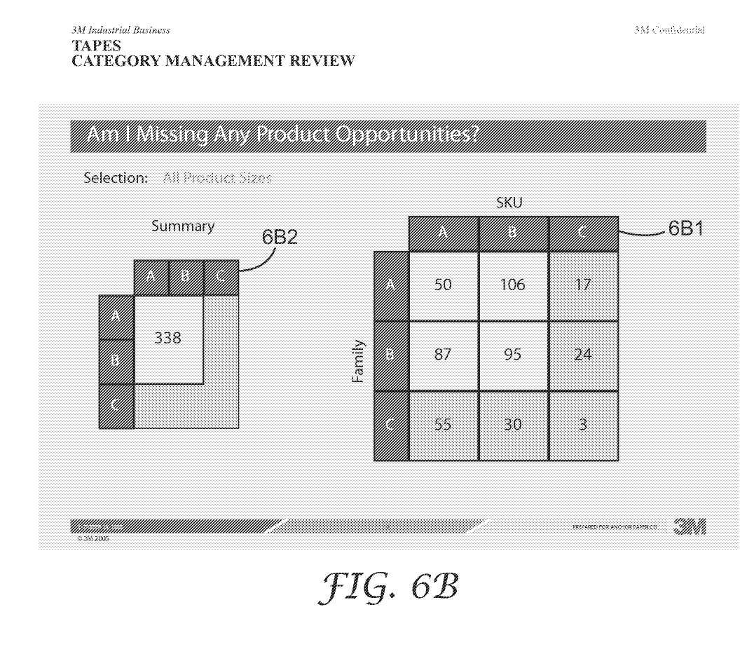

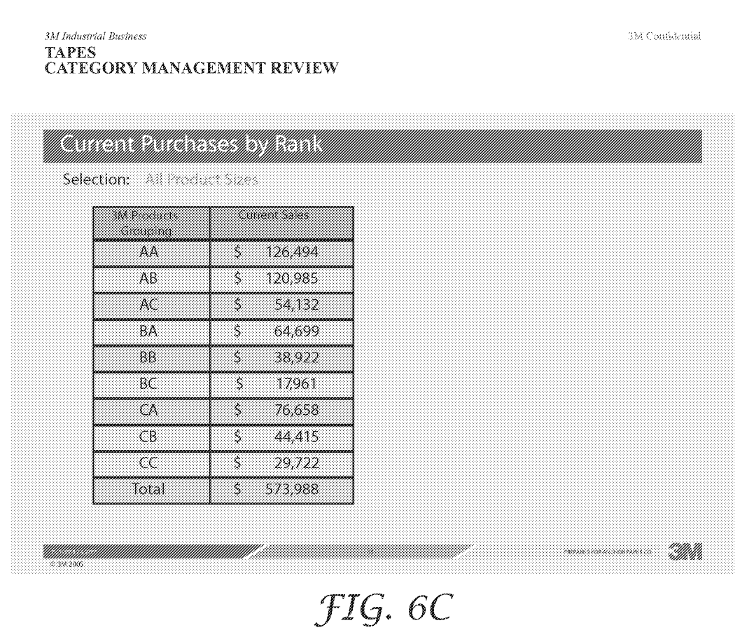

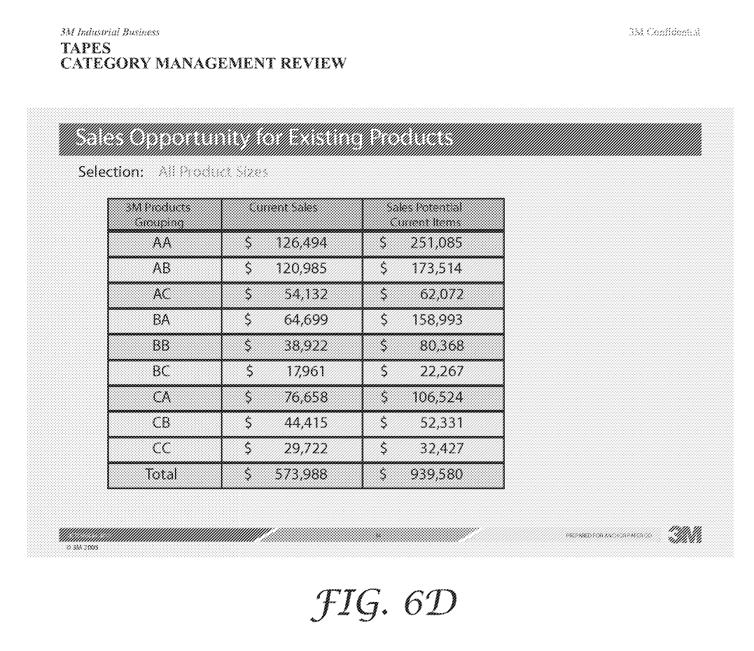

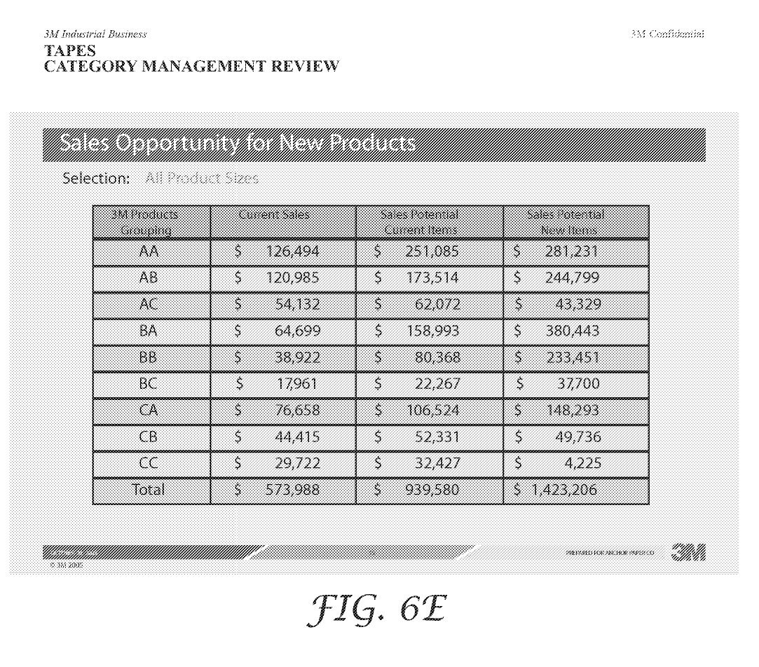

FIGS. 6A through 6E are example electronic media automatically and efficiently generated for a sample product selection report 5 created for a hypothetical distributor 6. FIG. 6E shows a breakdown of the distributor's current portfolio. Display region 6A1 shows the number of products distributor is selling sorted into a 4 by 4 matrix. The Y-axis of the matrix represents the various families in the category, split into one of four groups (A-D) by the process described above. The X-axis shows a similar ranking into four groups of the individual products that comprise the families. For example, for the various families that comprise the first row (A), distributor carries 43 products. Display region 6A2 shows a summary of the distributor's product mix within various segments of the matrix. The distributor might question, here, why it is carrying the same number of slower-moving CC products as it is faster moving AA, AB, BA products (61 in both cases).

FIG. 6B shows a category view similar to FIG. 6A, but from the manufacturing company's perspective. That is, FIG. 6B shows a breakdown of products within the same category that are available to distributor. Display region 6B1 in this case is limited to products CC or better, so as to emphasize higher volume products. Display region 6B2 shows the number of products of category AA, AB, BA—in this case 338.

FIG. 6C shows a breakdown of distributor's sales by product grouping.

FIG. 6D is a report showing the distributor's current sales, and a further column showing the potential sales the distributor could achieve for that same current set of products.

FIG. 6E is a report showing the distributor's current sales, and potential sales of current items as in FIG. 6D, but adding a further column, “Sales Potential New Items.” This column contains estimated revenue amounts the distributor could expect by carrying new products within the product grouping.

Various implementations and embodiments of the invention have been described. Nevertheless, it is understood that various modifications can be made without departing from the invention. Accordingly, these and other embodiments are within the scope of the following claims.

1. A computer-implemented system comprising:
an enterprise-wide goods and services database storing data that identifies one or more products or services of an enterprise having a plurality of business units, each business unit offering for sale a plurality of products or services;
an enterprise-wide order database storing sales data that identifies past sales of the enterprise's goods and services;
a product selection system comprising:
a user interface to identify a reseller profile that identifies at least one of the enterprise's resellers, or at least one of the enterprise's potential resellers, and defines at least one characteristic specific to the identified reseller or potential resellers; and,
an analytical engine executing on one or more computers, wherein the analytical engine calculates a reseller-specific product selection recommendation based on the reseller profile, the sales data, and the goods and services data.

2. The system of claim 1, the product selection system further comprising:
a report generation module that generates an electronic report that contains at least some of the reseller-specific product selection recommendations.

3. The system of claim 1, wherein the set of recommended products improves the reseller's return on investment over that reseller's current product selection.

4. The system of claim 1, wherein the analytical engine calculates the reseller-specific product selection recommendation by:
determining a first set of products the reseller is not carrying;
associating a sales-related attribute to at least one product in the first set of products;
prioritizing the first set of products based on the sales-related attribute; and,
selecting a second set of products based on the prioritized first set of products, the second set of products being the product selection recommendation.

5. The system of claim 4, wherein the sales-related attribute is among the following:
revenue, profitability, economic profitability, or volume.

6. A computer-implemented method comprising:
receiving, as input, a reseller profile that at least identifies a reseller or potential reseller of an enterprise, the enterprise being a manufacturing company having a plurality of business units, each business unit having a plurality of products, and the enterprise having both a goods and services database that defines thousands of product available for purchase from the enterprise, and an ordering system that defines particular products that have been sold to particular resellers;
accessing the enterprise's goods and services database to retrieve a first set of products that defines a plurality of products available for purchase form the enterprise and not currently sold by the reseller or potential reseller;
accessing the enterprise's ordering system to retrieve reseller product data that defines at least one product of the enterprise recently purchased by the reseller or potential reseller; and,
executing software of a product selection system to automatically provide an electronic report suggesting a set of the products that are among the first set of products, the report based on the reseller product data.

7. (canceled)

8. A computer-implemented method, comprising:
receiving as input, enterprise product data, which defines a plurality of products available for purchase by a reseller;
receiving as input product group data, which defines groups of related products, the groups comprised of products defined by the enterprise product data;
receiving as input enterprise sales data, which defines at least one business-related attribute about at least one of the plurality of products defined the enterprise product data, wherein the business-related attribute is revenue, profitability, economic profitability, or volume;
receiving as input reseller product data, which defines at least one product sold by the reseller;
receiving as input reseller non-carried product data, which defines at least one product not presently sold be the reseller; and
in response to the input, executing software of a product selection system to determine a suggested product set comprising products in the same group as the product sold by the reseller, but being among the reseller non-carried product data, that have a business-related attribute that is higher for each of the plurality of products in the same group than for the product sold by the reseller, then automatically providing an electronic report suggesting at least one of the products that is among the suggested product set.

9. The method of claim 8, wherein related products are products used for the same task.

10. The method of claim 8, further comprising:
providing the electronic report to the reseller.

11. The method of claim 8, wherein related products are products made of the same material.

12. A computer-implemented method, comprising:
receiving as input enterprise product data, which defines a plurality of products available for purchase by a reseller, and for each product defines the product's category and the product's family, wherein the product category is a class of associated products, and the product family is a sub-class of associated products;
receiving as input enterprise sales data, which defines at least one business-related attribute about at least one of the plurality of products defined the enterprise product data;
receiving as input reseller product data, which defines at least one product sold by the reseller;
determining reseller non-carried product data, which defines at least one product not presently sold be the reseller, by comparing enterprise product data with reseller product data;
assigning at least some products in the non-carried product data a category-family ranking, wherein the category-family ranking defined a ranking for families of products within categories of products, the ranking by the business-related attribute;
assigning at least some products in the non-carried product data a product-family ranking, wherein the product-family ranking defines a ranking for products within families, the ranking by a business-related attribute; and,
generating a product selection recommendation based on the category-family ranking and the product-family ranking.

13. The computer-implemented method of claim 12, wherein the business-related attribute is revenue, profitability, economic profitability, or volume.

14. A computer-readable medium having computer-executable instructions for performing a method comprising:
receiving a reseller profile that at least identifies a reseller or potential reseller of an enterprise, the enterprise having a plurality of business units, each business unit having a plurality of products, and the enterprise having both a goods and services database that defines at least one product available for purchase from the enterprise, and an ordering system that defines particular products that have been sold to particular resellers;
accessing the enterprise's goods and services database to retrieve a a first set of products that defines at least one product available for purchase from the enterprise and not currently sold by the reseller or potential reseller;
accessing the enterprise's ordering system to retrieve a reseller-carried product, which is data that defines a product of the enterprise purchased by the reseller or potential reseller;
receiving information defining product family information for the reseller product data, the product family information comprising data describing other products that are related to product defined by the reseller product data; and
in response to the input, executing software of a product selection system to automatically provide an electronic report suggesting a set of the products from the first set of products that are among the same product family as the reseller-carried product.

15. The computer-readable medium of claim 14, further comprising:
ranking products in the reseller-carried product family by a business-related attribute; and wherein the set of products suggested in the electronic report is a subset of the products in the reseller-carried product family.

16. A computer-readable medium having computer-executable instructions for performing a method comprising:
receiving as input enterprise product data, which defines a plurality of products available for purchase by a reseller;
receiving product group data, which defines groups of related products;
receiving enterprise sales data, which defines at least one business-related attribute about at least one of the plurality of products defined the enterprise product data, wherein the business-related attribute is revenue, economic profitability, or volume;
receiving reseller product data, which defines at least one product sold by the reseller;
receiving reseller non-carried product data, which defines at least one product not presently sold be the reseller; and,
in response to the input, executing software of a product selection system to determine a suggested product set comprising products in the same group as the product sold by the reseller, but being among the reseller-non-carried product data, the suggested product set determined by ranking the products in the same group as the product sold by the reseller by the business-related attribute.

17. The method of claim 16, wherein the business-related attribute is revenue, profitability, economic profitability, or volume.

18. The method of claim 16, further comprising:
providing the suggested product set to the reseller.

19. The method of claim 16, further comprising:
printing the suggested product set on paper.

20. A computer-readable medium having computer-executable instructions for performing a method comprising:
receiving as input enterprise product data, which defines a plurality of products available for purchase by a reseller, and for each product defines the product's category and the product's family, wherein the product category is a class of associated products, and the product family is a sub-class of associated products;
receiving as input enterprise sales data, which defines at least one business-related attribute about at least one of the plurality of products defined the enterprise product data;
receiving as input reseller product data, which defines at least one product sold by the reseller;
determining reseller non-carried product data, which defines at least one product not presently sold be the reseller, by comparing enterprise product data with reseller product data;
assigning at least some products in the non-carried product data a category-family ranking, wherein the category-family ranking defines a ranking for families of products within categories of products, the ranking by a business-related attribute;
assigning at least some products in the non-carried product data a product-family ranking wherein the product-family ranking defines a ranking for products within families, the ranking by a business-related attribute; and
generating a product selection recommendation based on the category-family ranking and the product-family ranking.

21. The computer-readable medium of claim 20, wherein the business-related attribute is revenue, profitability, economic profitability, or volume.

22. The computer-implemented method of claim 6, further comprising:
ranking the first set of products by a business-related attribute;
and wherein the electronic report presents the products by the ranking.

23. The computer-implemented method of claim 22, wherein the business-related attribute is sales volume or profitability.

24. The computer-implemented method of claim 6, further comprising:
receiving product family data that defines other products in the same family as the product recently purchased by the reseller or potential reseller.

25. The computer-implemented method of claim 24, further comprising:
for a given product, developing a second set of products comprised of products that are among the first set of products and in the same product family;
and wherein the electronic report presents the first set of products that are among the second set of products.

26. A computer readable medium having computer-executable instructions for performing the computer-implemented method of claim 6.

27. A computer-readable medium having computer-executable instructions for performing the computer-implemented method of claim 25.
